(19) United States
(12) Patent Application Publication
(10) Pub. No.: US 2011/0225044 A1
(43) Pub. Date: Sep. 15, 2011

(54) Mobile/Internet Advertising Integration System

(76) Inventor: Michael Duffy, Austin, TX (US)

(21) Appl. No.: 13/044,600

(22) Filed: Mar. 10, 2011

Related U.S. Application Data
(60) Provisional application No. 61/339,854, filed on Mar. 10, 2010.

(51) Int. Cl. G06Q 30/00

(52) U.S. Cl. 705/14.53; 705/14.66

(57) ABSTRACT

The Mobile/Internet Advertising Integration System is a method for creating highly targeted advertisements based on a digital consumer profile that will be integrated into a user's electronic device (e.g., mobile phone). This consumer profile will in the most likely embodiment be paired with a users digital wallet and digital rewards manager applications. Every purchase the user makes, every website the consumer interacts with, every digital display add the consumer views will modify his/her consumer profile and possibly add coupons or special offers into his/her digital rewards manager.

### CROSS-REFERENCE TO RELATED APPLICATIONS

Filing Date Based on Provisional Application 61/339,854

### STATEMENT REGARDING FEDERALLY SPONSORED RESEARCH OR DEVELOPMENT

N/A

### THE NAMES OF THE PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

(1). Feld of the Invention

Mobile/Internet Advertising

(2) Description of Related Art Including Information Disclosed Under 37 CFR 1.97 and 1.98

While there are many patents related to Internet advertising systems and mobile advertising systems, this patent is unique in that it describes of process in which a consumer profile from a mobile device interacts with an Internet advertising system to create highly targeted consumer advertisements. While this process may seem like an eventuality today, given the widespread emergence of NFC enabled smart phones, in March of 2010 this was a unique, leading edge concept.

### BRIEF SUMMARY OF THE INVENTION

A process in which a consumer profile from a mobile device interacts with an Internet based advertising management system to create highly targeted consumer advertisements.

### BRIEF DESCRIPTION OF THE SEVERAL VIEWS OF THE DRAWING(S)

N/A

### DETAILED DESCRIPTION OF THE INVENTION

The digital wallet on NFC enabled cell phones will be one of the most valuable assets in the digital age. In addition to new methods for authentication and financial transactions, the digital wallet and supporting infrastructure will enable the creation of new marketing/advertising models.

One of the key features of the digital wallet will be the enablement of new marketing/advertising models that that are light years beyond the simple advertising managers currently available. Extreme target marketing and detailed information tailored to specific users will be become a reality.

The unique aspect of the digital wallet is that it is not a “dumb card” or even a limited “smart cart”; it is an application that can manage information flows.

In creating the standards for the digital wallet we will create an option that will allow additional information (service provider, item descriptor, amount, transaction type, etc.) to be sent to the digital wallet along with the transaction ID. This information will then flow to the The Trust Nexus Marketing Infrastructure. Retailers, both Internet and traditional brick and mortar, will welcome this option because they will benefit from the marketing infrastructure.

While privacy issues will need to be addressed in a forthright manner, there is no doubt these issues can be addressed. On a specific basis, consumers will be able to “opt in” or “opt out” of the system for storing marketing data. Also, there will most likely be government set limits on the type of data that can and cannot be stored (medical services, prescriptions, legal services, etc.) and a time limit for how long any data can be stored.

Consumers will have access to an Internet service (accessible by mobile) where they will be able to set and check their marketing preferences, receive special offers and manage their rewards programs.

As a simple example, the profile manager in a consumer's digital wallet could interact with the retail POS system at the local Starbucks. During a purchase the barista could ask the customer if he/she would like to receive special offers from Starbucks; just for signing up the customer would receive a digital coupon for a free grande beverage of their choice.

In accepting the offer a consumer would also agree to allow the The Trust Nexus Marketing Infrastructure to track his/her purchases at Starbucks (and possibly other coffee shops and maybe even all types of coffee purchases). The Trust Nexus Marketing Infrastructure would pass this information on to Starbucks which would use the information in a variety of ways (target advertising, coupons, rewards cards, etc.).

NFC technology will enable an integration between the desktop and mobile platforms. All computers will soon have an NFC interface (either an internal card or a portal device plugged into a USB port). NFC enabled cell phones will be able to exchange information with the desktop platform for a variety of purposes (single sign on, financial transactions, marketing profiles, etc.).

There will be a process in which a consumer's profile manager from his/her digital wallet will interact with a website's advertising manager to provide extreme target advertising. A consumer who has not been to Starbucks recently may see a web advertisement for a special “digital deal” on his/her favorite beverage from Starbucks. With a simple click the “digital deal” could be downloaded to the consumers digital Starbucks Rewards card.

The full potential of the The Trust Nexus Marketing Infrastructure will be realized when the Starbucks example is scaled up to a comprehensive consumer management/brand management system for Walmart, Amazon.com, Target, etc. The possibilities are truly incredible. No doubt there are potentials not yet imagined.

Digital wallets on NFC enabled cell phones will open a new world of dynamically generated advertising. The NFC capabilities will enable a user's cell phone to transmit a marketing profile from a user's digital wallet to an electronic advertising network within a retail store or within a specific geographic area. Electronic displays/billboards will dynamically generate advertising messages directed to specific users. Special promotions (coupons, discounts, etc.) will be communicated directly to specific users as mobile advertising.

For the most part, the mobile platform and the desktop platform have operated as separate entities with limited interaction. This situation will change dramatically as NFC enabled cell phones become the primary device for identity and financial transactions.

One of the new interactions between the desktop platform and the cell phone platform will be integrated personalization. Marketing profiles from a user's digital wallet will be integrated into the user's desktop experience. As one example, The Trust Nexus will enable the integration of personalized searches and new advertising models into search engines. The success of Google is essentially the success of an advertising model. Personalized searches and new advertising models will enable other search engines to offer a significant competitive challenge to Google.

The potential of The Trust Nexus to gather real time economic data from across the world should provide incredible analytics for marketing and economic research.

1. A method for creating highly targeted advertising, comprising the steps of:
a. Creating a consumer profile on an electronic device.
b. Transmitting the consumer profile to an advertising management system.
c. Selecting advertisement(s) based on the consumer profile.
d. Transmitting the advertisement(s) to an Internet web page and/or the electronic device.

2. The method of claim 1 where the electronic device is a mobile device

3. The method of claim 1 where the electronic device is a mobile phone.

4. The method of claim 1 where the electronic device is a mobile tablet.

5. The method of claim 1 where the advertising management system is Internet based.

6. The method of claim 1 where the advertising management system is Cloud based.

7. The method of claim 1 where the advertising management system is integrated into a retail point of sale system.

8. The method of claim 1 where the consumer profile is modified based on the advertisement(s) selected.

9. The method of claim 1 where the consumer profile is modified based on the user's action(s) (e.g., clicking on a specific option within the advertisement).

10. The method of claim 1 where the advertisement is transferred to and stored on the electronic device.

11. The method of claim 1 where the advertisement contains coupons or other special offers that can be integrated into the user's consumer profile or digital rewards manager (an additional application residing on the electronic device).

12. The method of claim 1 where the consumer processes are integrated into the electronic device (e.g., an integrated smart phone/tablet that contains the consumer's profile, digital rewards manager, digital wallet, and enables the consumer to interact with an Internet browser on the electronic device, a retail point of sale system, digital advertising display systems and of the consumer interactions).
